(19) United States
(12) Patent Application Publication
(10) Pub. No.: US 2011/0123263 A1
(43) Pub. Date: May 26, 2011

(54) Device for Fastening Clash Pad to Vehicle

(75) Inventor: Ho Sik CHOI, Whasung-Si (KR)

(73) Assignees: Hyundai Motor Company, Seoul (KR); Kia Motors corporation, Seoul (KR)

(21) Appl. No.: 12/707,394

(22) Filed: Feb. 17, 2010

(30) Foreign Application Priority Data
Nov. 25, 2009 (KR) 10-2009-0114723

(51) Int. Cl. F16B 21/10

(52) U.S. Cl. 403/315

(57) ABSTRACT

A device for fastening a clash pad to a vehicle, may include a grommet having a clash pad connection portion for placing in a hole formed in the clash pad, a stud bolt holder connected to the clash pad connection portion and including a receiving hole for receiving a stud bolt at a cowl panel of a vehicle body, and a mounting shelf clip connected to the stud bolt holder for placing on and fastening to a mounting flange at the cowl panel of the vehicle body, wherein the clash pad is fastened to the vehicle body as the stud bolt holder or the mounting shelf clip is placed on the stud bolt or the mounting flange, respectively.

### CROSS-REFERENCE TO RELATED APPLICATION

The present application claims priority to Korean Patent Application No. 10-2009-0114723, filed on Nov. 25, 2009, the entire content of which is incorporated herein for all purposes by this reference.

### BACKGROUND OF THE INVENTION

1. Field of the Invention

The present invention relates to a device for fastening clash pad to a vehicle body to reduce rattling noise from a clash pad, and, more particularly, to a device for fastening clash pad to a vehicle body, in which a soft synthetic resin layer is formed on an inside surface of a grommet type clash pad fastening device for reducing rattling noise from a clash pad, enabling easy fastening the grommet type clash pad fastening device to the clash pad and making the grommet type clash pad fastening device applicable to all kinds of vehicles.

2. Description of Related Art

In general, the clash pad in a car is fastened to a car body with a nozzle duct unified mounting shelf clip type clash pad fastening device or a grommet type clash pad fastening device.

FIG. 1 illustrates a perspective view of a clash pad of a related art grommet type clash pad fastening device, and FIG. 2 illustrates a longitudinal cross section of key parts of a related art grommet type clash pad fastening device.

FIG. 3 illustrates a front view of a grommet of the related art grommet type clash pad fastening device.

Referring to FIGS. 1 and 2, the related art grommet type clash pad fastening device is provided with a grommet 105 to be fastened to a clash pad 103 with tapping screws, the grommet 105 having a fasting portion 106 to be placed on a stud bolt 102 welded to a cowl panel of a car body.

However, the related art grommet type clash pad fastening device has a problem in that a permanent deformation takes place at the clash pad fastening device as the fastening portion 106 of the grommet 105 is aged, to form a gap between the fastening portion 106 and the stud bolt 102, making rattling noise at the time the car is running.

Referring to FIG. 3, in order to solve this problem, though a plurality of rattling preventive pads 107 are applied to the fastening portion 106 of the grommet 105, the rattling preventive pads 107, not only fail to prevent the clash pad 103 from reducing the rattling noise, but also cause high cost due to many components required.

FIG. 4 illustrates a perspective view of key parts of a related art mounting shelf clip type clash pad fastening device.

Referring to FIG. 4, the mounting shelf clip type clash pad fastening device is provided with a nozzle duct unified mounting shelf clip 202 formed on a clash pad 203 placed in a mounting shelf clip flange 201 at a cowl panel of the body to fasten the clash pad. Since the nozzle duct unified mounting shelf clip 202 is joined with the clash pad 203 by vibratory fusion, only manufacturers having required equipment can carry out above operation for a limited kinds of vehicles, and the related art mounting shelf clip type clash pad fastening device also causes the rattle noise as a permanent deformation of the fastening device takes place following aging of the fastening device.

In the meantime, Japanese laid open patent publication No. 1993-63980 discloses a technology in which a slot is formed in a left side of a cowl cross bar and a hole is formed on a right side of the cowl cross bar such that a clash pad is positioned between opposite ends of a body cowl side panel when the clash pad is mounted (non-modular type), to make gaps between opposite ends of the clash pad and the cowl side panel is uniform after mounting of the clash pad.

Japanese laid open patent publication No. 1995-309154 discloses a technology in which the clash pad is fastened with a pin at an upper end of a clash pad pass through a hole in a bracket fixed to a car body at first, and the clash pad is fastened for the second time by another bracket fixed to a cowl cross bar, a nut at the bracket and a bolt fastened to the nut through the hole in the clash pad.

However, the Japanese disclosures fail to disclose a technology for reducing the rattling noise of the clash pad even though the disclosures disclose accurate positioning or easy mounting of the clash pad.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a device for fastening a clash pad to a vehicle body and to provide a device for fastening a clash pad to a vehicle body, in which grommet is made to reduce rattling noise of the clash pad, enabling easy fastening of the grommet type clash pad fastening device to the clash pad and making the grommet type clash pad fastening device applicable to all kinds of vehicles.

In an aspect of the present invention, the device for fastening a clash pad to a vehicle, may include a grommet having a clash pad connection portion for placing in a hole formed in the clash pad; a stud bolt holder connected to the clash pad connection portion and including a receiving hole for receiving a stud bolt at a cowl panel of a vehicle body; and a mounting shelf clip connected to the stud bolt holder for placing on and fastening to a mounting flange at the cowl panel of the vehicle body, wherein the clash pad is fastened to the vehicle body as the stud bolt holder or the mounting shelf clip is placed on the stud bolt or the mounting flange, respectively.

The mounting shelf clip may be fastened to the clash pad connection portion.

The stud bolt holder may include at least an elastic projection in the receiving hole thereof, wherein the at least an elastic projection is formed in an upper side and a lower side of the receiving hole, respectively, and wherein the at least an elastic projection has a tension over lap between approximately 0.3 mm and approximately 0.8 mm.

The hole in the clash pad may be rectangular and a portion of the clash pad connection portion may be rectangular with arc shaped sides so that the portion of the clash pad connection portion can be press fit to the hole in the clash pad with line to line contact, wherein the clash pad connection portion includes at least a cushion hole in the arc shaped sides thereof, and wherein the portion of the clash pad connection portion has contact surfaces contacting with the hole of the clash pad, each of the contact surface having a tension over lap between approximately 0.5 mm and approximately 1.5 mm.

In another aspect of the present invention, the device may include a soft synthetic resin layer on an inside surface of the receiving hole of the stud bolt holder and a soft synthetic resin layer on an inside surface of the mounting shelf clip.

In further another aspect of the present invention, the grommet may be formed of PPF (Polypropylene Mineral Filled) as a basic material, and an inside surface of the mounting shelf clip and an inside surface of the receiving hole of the stud bolt holder may be covered with synthetic resin layers of TPO (Olefinic thermoplastic elastomer), wherein the inside surfaces of the mounting shelf clip and the receiving hole of the stud bolt holder are portions in direct contact with the stud bolt and the mounting plate fixed to the vehicle body respectively.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 illustrates a perspective view of a clash pad of a related art grommet type clash pad fastening device.

FIG. 2 illustrates a longitudinal cross section of key parts of a related art grommet type clash pad fastening device.

FIG. 3 illustrates a front view of a grommet of the related art grommet type clash pad fastening device.

FIG. 4 illustrates a perspective view of key parts of a related art mounting shelf clip type clash pad fastening device.

FIG. 5 illustrates a perspective view of a grommet in accordance with an exemplary embodiment of the present invention.

FIG. 6 illustrates a longitudinal cross-section showing a mounting state of a clash pad in accordance with an exemplary embodiment of the present invention.

FIG. 7 illustrates a longitudinal cross-section showing a stud bolt holder of a clash pad in accordance with an exemplary embodiment of the present invention.

FIG. 8 illustrates a perspective view of key parts of another exemplary embodiment of the present invention.

FIG. 9 illustrates a longitudinal cross section of key parts of another exemplary embodiment of the present invention.

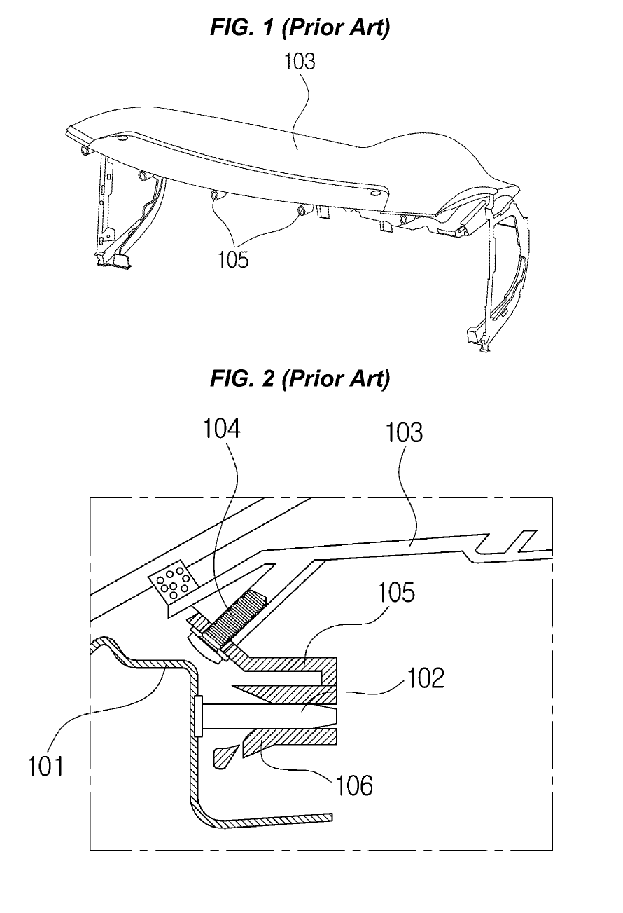

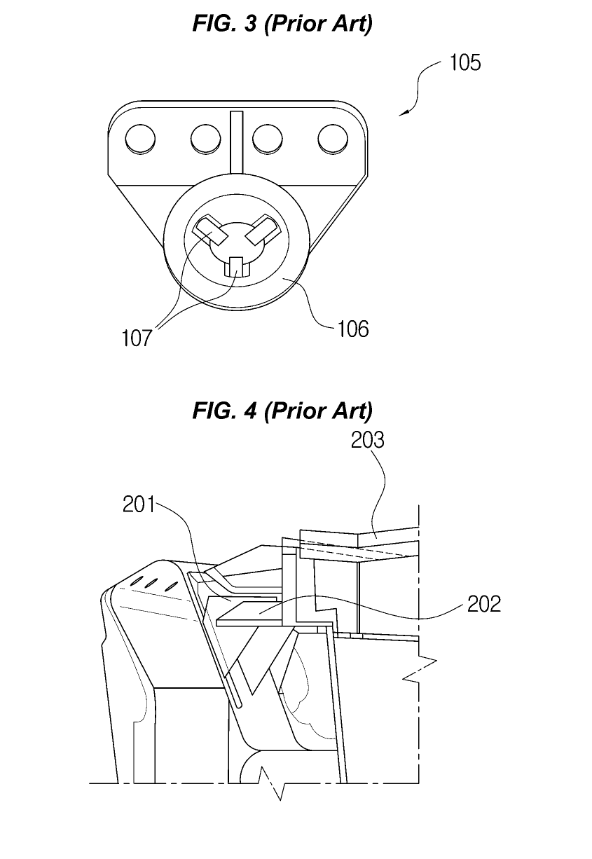

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

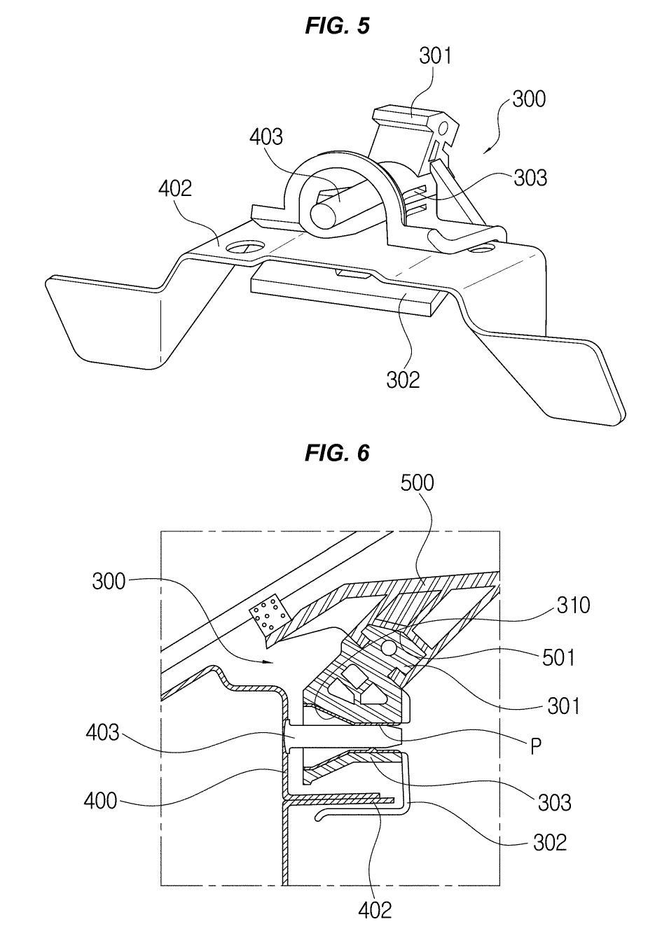

FIG. 5 illustrates a perspective view of a grommet in accordance with an exemplary embodiment of the present invention, and FIG. 6 illustrates a longitudinal cross-section showing a mounting state of a clash pad in accordance with an exemplary embodiment of the present invention.

Referring to FIGS. 5 and 6, the clash pad fastening device to a vehicle includes a grommet 300 having a mounting shelf clip 302 under a clash pad connection portion 301 for placing on and fastening to a mounting flange 402 at a cowl panel 400 of a vehicle body, and a stud bolt holder 303 over a center of the mounting shelf clip 302 for placing on a stud bolt 403 at cowl panel 400 of a vehicle body.

According to an exemplary embodiment of the present invention, there may be a soft synthetic resin layers P on an inside surface of the mounting shelf clip 302 of the grommet 300 and on an inside surface of an receiving hole 310 of the stud bolt holder 303, respectively. The grommet is formed of a synthetic resin having an excellent rigidity as a basic material, with the soft synthetic resin layers P respectively placed on the inside surface of the mounting shelf clip 302 and on the inside surface of the stud bolt holder 303 which are portions in direct contact with the stud bolt 403 and the mounting plate 402 fixed to the vehicle body respectively for preventing the rattling noise from occurring.

The synthetic resin having an excellent rigidity may be PPF (Polypropylene Mineral Filled), and the soft synthetic resin may be TPO (Olefinic thermoplastic elastomer).

Even if the grommet 300 of the soft synthetic resin can not sustain fastening strength between the clash pad 500 and the car body, the grommet 300 applied to the clash pad fastening device to a car body of the present invention of synthetic resin having an excellent rigidity, such as PPF, can sustain fastening strength between the clash pad 500 and the car body.

The grommet 300 is fixedly secured to the clash pad 500 as the clash pad connection portion 301 is placed in a hole 501 in the clash pad 500, enabling to fasten the clash pad 500 to the car body through the grommet 300. In a case of a car having a stud bolt 403 fixed to a car body cowl panel 400, the stud bolt holder 303 of the grommet 300 is placed on the stud bolt 403, through the receiving hole 310 thereof, to fasten the clash pad 500 to the car body. In a case of a car having the mounting flange 402 mounted to the car body cowl panel 400, the mounting shelf clip 302 of the grommet 300 is placed in the mounting flange 402 to fasten the clash pad 500 to the car body.

Eventually, the clash pad fastening device to a car of the present invention makes the grommet 300 applicable to almost all kinds of cars.

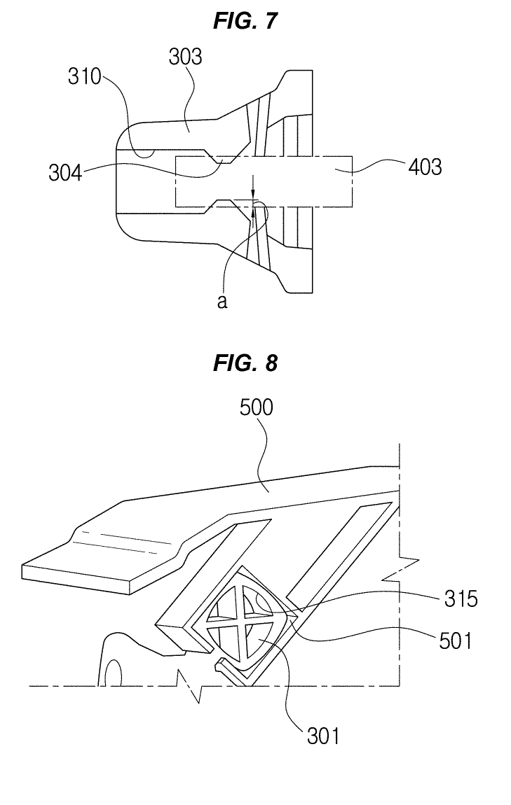

FIG. 7 illustrates a longitudinal cross-section showing a stud bolt holder of a clash pad in accordance with an exemplary embodiment of the present invention. As shown, in a case if the stud bolt holder 303 of the grommet 300 has elastic projections 304 from an upper side and a lower side of the stud bolt holder 303 respectively, the grommet 300 can be fastened to the stud bolt 403, more securely. In this instance, it is preferable that the elastic projection 304 has a tension overlap ‘a’ of 0.3˜0.8 mm, and more preferably, 0.5 mm.

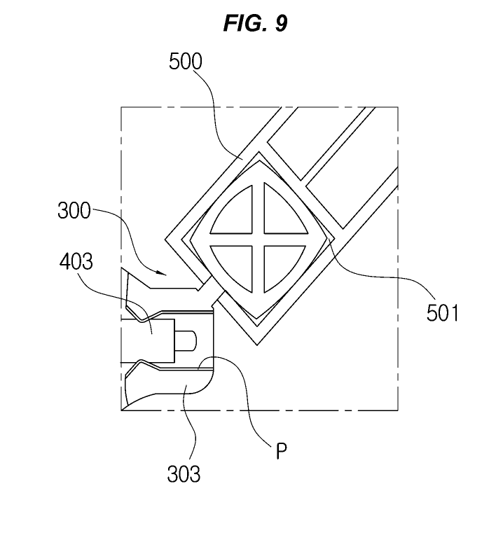

FIG. 8 illustrates a perspective view of key parts of another exemplary embodiment of the present invention, and FIG. 9 illustrates a longitudinal cross section of key parts of another exemplary embodiment of the present invention. As shown, the hole 501 in the clash pad 500 can be rectangular, and the clash pad connection portion 301 of the grommet 300 can be rectangular in conformity with the hole 510 with arc shaped sides and include at least a cushion hole 310. According to this, the clash pad connection portion 301 of the grommet 300 can be press-fit to the hole 510 in the clash pad 500 with line to line contact therebetween to fix the grommet 300 to the clash pad 500, rigidly. In this instance, it is preferable that each of contact surfaces has a tension overlap of 0.5˜1.5 mm, and more preferably, about 1 mm.

As has been described, the clash pad fastening device, in various aspects of the present invention, has the following advantages.

The soft synthetic resin layers on the inside surfaces of the stud bolt holder and the mounting shelf clip can reduce the rattle noise from the clash pad, to improve a sense of quality of the vehicle, and enable the grommet applicable to almost all kinds of vehicles.

Since neither tapping screw nor nonwoven fabric pad is used, enabling to reduce a number of required components, weight and cost can be reduced, substantially.

For convenience in explanation and accurate definition in the appended claims, the terms “upper” and “lower” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A device for fastening a clash pad to a vehicle, comprising:
a grommet including;
a clash pad connection portion for placing in a hole formed in the clash pad;
a stud bolt holder connected to the clash pad connection portion and including a receiving hole for receiving a stud bolt at a cowl panel of a vehicle body; and
a mounting shelf clip connected to the stud bolt holder for placing on and fastening to a mounting flange at the cowl panel of the vehicle body,
wherein the clash pad is fastened to the vehicle body as the stud bolt holder or the mounting shelf clip is placed on the stud bolt or the mounting flange, respectively.

2. The device as claimed in claim 1, wherein the mounting shelf clip is fastened to the clash pad connection portion.

3. The device as claimed in claim 1, wherein the stud bolt holder includes at least an elastic projection in the receiving hole thereof.

4. The device as claimed in claim 3, wherein the at least an elastic projection is formed in an upper side and a lower side of the receiving hole, respectively.

5. The device as claimed in claim 3, wherein the at least an elastic projection has a tension over lap between approximately 0.3 mm and approximately 0.8 mm.

6. The device as claimed in claim 1, wherein the hole in the clash pad is rectangular and a portion of the clash pad connection portion is rectangular with arc shaped sides so that the portion of the clash pad connection portion can be press fit to the hole in the clash pad with line to line contact.

7. The device as claimed in claim 6, wherein the clash pad connection portion includes at least a cushion hole in the arc shaped sides thereof.

8. The device as claimed in claim 6, wherein the portion of the clash pad connection portion has contact surfaces contacting with the hole of the clash pad, each of the contact surface having a tension over lap between approximately 0.5 mm and approximately 1.5 mm.

9. The device as claimed in claim 1, further comprising a soft synthetic resin layer on an inside surface of the receiving hole of the stud bolt holder.

10. The device as claimed in claim 1, further including a soft synthetic resin layer on an inside surface of the mounting shelf clip.

11. The device as claimed in claim 1, wherein the grommet is formed of PPF (Polypropylene Mineral Filled) as a basic material, and an inside surface of the mounting shelf clip and an inside surface of the receiving hole of the stud bolt holder are covered with synthetic resin layers of TPO (Olefinic thermoplastic elastomer), and wherein the inside surfaces of the mounting shelf clip and the receiving hole of the stud bolt holder are portions in direct contact with the stud bolt and the mounting plate fixed to the vehicle body respectively.

12. The device as claimed in claim 11, wherein the stud bolt holder includes at least an elastic projection in the receiving hole thereof.

13. The device as claimed in claim 12, wherein the at least an elastic projection is formed in an upper side and a lower side of the receiving hole, respectively.

14. The device as claimed in claim 12, wherein the at least an elastic projection has a tension over lap between approximately 0.3 mm and approximately 0.8 mm.

15. The device as claimed in claim 11, wherein the hole in the clash pad is rectangular and a portion of the clash pad connection portion is rectangular with arc shaped sides so that the portion of the clash pad connection portion can be press fit to the hole in the clash pad with line to line contact.

16. The device as claimed in claim 15, wherein the clash pad connection portion includes at least a cushion hole in the arc shaped sides thereof.

17. The device as claimed in claim 15, wherein the portion of the clash pad connection portion has contact surfaces contacting with the hole of the clash pad, each of the contact surface having a tension over lap between approximately 0.5 mm and approximately 1.5 mm.
